(19) United States
(12) Patent Application Publication
(10) Pub. No.: US 2008/0243423 A1
(43) Pub. Date: Oct. 2, 2008

(54) Method For the Indirect Tire Pressure Monitoring

(75) Inventors: Markus Irth, Mainz-Kastel (DE); Andreas Kobe, Bensheim (DE); Christian Sussman, Oberursel (DE); Franko Blank, Hodenhang (DE); Vladimir Koukes, Darmstadt (DE)

Correspondence Address: CONTINENTAL TEVES, INC., ONE CONTINENTAL DRIVE, AUBURN HILLLS, MI, 48326-1581, US

(73) Assignee: Continental Teves AG & Co., oHG

(21) Appl. No.: 12/093,620

(22) PCT Filed: Nov. 14, 2006
(86) PCT No.: PCT/EP06/68440

§ 371 Date: May 14, 2008

(30) Foreign Application Priority Data
Nov. 14, 2005 (DE) 10 2005 054 556.4
Nov. 14, 2006 (DE) 10 2006 053 826.9

(51) Int. Cl. G01L 19/00; G01M 17/02

(52) U.S. Cl. 702/138; 73/146

(57) ABSTRACT

Method for the indirect tire pressure monitoring in which there are performed a rolling circumference analysis of the tires, in which rolling circumference analysis variables (ΔDIAG, ΔSIDE, ΔAXLE) are determined from actually found and learnt test variables describing the rotation of the wheels, and a frequency analysis of the natural oscillation behavior of at least one tire in which at least one frequency analysis variable (fₖ) is determined, in which case an evaluation of the rolling circumference analysis (A) and the natural frequency analysis (C) and a combined evaluation (B) of both methods of analysis is performed for warning indication of tire pressure loss.

### BACKGROUND OF THE INVENTION

The present invention relates to a method for the indirect tire pressure monitoring in which there are performed a rolling circumference analysis of the tires, in which rolling circumference analysis variables (ΔDIAG, ΔSIDE, ΔAXLE) are determined from actually found and learnt test variables describing the rotation of the wheels, and a frequency analysis of the natural oscillation behavior of at least one tire in which at least one frequency analysis variable (fₖ) is determined and to a computer program product.

In up-to-date motor vehicles, systems are employed at an increasing rate, which contribute to an active or passive protection of the occupants. Systems for tire pressure monitoring protect the occupants of a vehicle against vehicle damages, which are due to an incorrect tire inflation pressure, for example. A non-adapted tire inflation pressure can also cause increase of e.g. tire wear and fuel consumption, or a tire defect (tire bursting) may occur. Various tire pressure monitoring systems are known, which operate either based on directly measuring sensors or detect an abnormal tire pressure by evaluating rotational speed properties or oscillating properties of the vehicle wheels.

German patent application DE 100 58 140 A1 discloses a so-called indirectly measuring tire pressure monitoring system (DDS: Deflation Detection System) detecting tire pressure loss by evaluating the rotational movement of the wheel.

EP 0 578 826 B1 discloses a device for determining tire pressure which determines pressure loss in a tire based on tire oscillations.

WO 01/87647 A1 describes a method and a device for tire pressure monitoring, combining a tire pressure monitoring system which is based on the detection of wheel radii, and a tire pressure monitoring system which is based on the evaluation of oscillation properties.

WO 05/072995 A1 discloses a method for tire pressure monitoring which improves an indirectly measuring tire pressure monitoring system by considering at least one torsion natural frequency to such effect that the safe detection of an abnormal tire inflation pressure is enhanced.

An object of the invention is to provide a tire pressure monitoring system for a motor vehicle based on the evaluation of the wheel rotation and the tire oscillations, in which the reliability of detection and warning indication of tire pressure losses is increased.

### SUMMARY OF THE INVENTION

According to the invention, this object is achieved by the method for the indirect tire pressure monitoring in which there are performed a rolling circumference analysis of the tires, in which rolling circumference analysis variables (ΔDIAG, ΔSIDE, ΔAXLE) are determined from actually found and learnt test variables describing the rotation of the wheels, and a frequency analysis of the natural oscillation behavior of at least one tire in which at least one frequency analysis variable (fₖ) is determined. An evaluation of the rolling circumference analysis (A) and the natural frequency analysis (C) and a combined evaluation (B) of both methods of analysis is performed for warning indication of tire pressure loss.

The invention is based on the idea of founding the warning strategy both on the separate evaluation of a rolling circumference analysis of the tires and on an analysis of the natural frequency of the tires as well as on a combination of the two analyses.

In the combination of the rolling circumference analysis and the frequency analysis, warning thresholds of each one of the two analysis methods are preferably adapted for warning purposes to the respectively other method depending on the results, e.g. on variables of the analysis. This allows improving the reliability of the warning indication. It is especially preferred to use the pressure loss analysis variables of the respectively other method for adapting the warning threshold(s).

It is likewise preferred that in the combination of the two methods of analysis, warning thresholds of each one of the two methods of analysis are chosen depending on the results of the respectively other method and a rate of correlation between the two methods of analysis. The rate of correlation describes to which extent the rolling circumference analysis and the frequency analysis reflect the same image of one or more pressure losses on the wheels. In this case, too, it is especially preferred to use the pressure loss analysis variables of the respectively other method in order to adapt the warning threshold(s).

According to a preferred embodiment, wheel-individual pressure loss analysis variables are determined in each case for the rolling circumference analysis and frequency analysis in the combination of both methods of analysis. This renders warning indication for each individual wheel and a combination of the two methods of analysis for each individual wheel possible. Warning thresholds of each of the two methods of analysis are especially preferred to be selected depending on the wheel-individual pressure loss analysis variables of the respectively other method.

According to an improvement of the invention, the warning thresholds are also changed depending on the availability of the analysis variables. The danger of a false alarm is reduced when an analysis method temporarily supplies no information or no reliable information.

A combined wheel-individual pressure loss analysis variable is preferred to be determined from the pressure loss analysis variables of the rolling circumference analysis and frequency analysis of the same wheel for at least one wheel, with particular preference for each wheel. It is especially preferred then to include also the warning thresholds or the common warning threshold of both methods of analysis. Furthermore, it is especially preferred to determine the combined wheel-individual pressure loss analysis variable by way of a characteristic field of warning. When the combined wheel-individual pressure loss analysis variable exceeds a threshold value, pressure loss can be concluded at the corresponding wheel.

In an improvement of the invention, a warning with regard to tire pressure loss is issued depending on at least two, with particular preference depending on all, of the combined wheel-individual pressure loss analysis variables.

Preferably, the warning takes place based on the maximum of the combined wheel-individual pressure loss analysis variables.

According to another preferred embodiment, a plausibility test of the determined value is performed for at least one of the analysis variables of the rolling circumference analysis, the natural frequency analysis or the combination of the two analyses. The change with time of the analysis variable is examined to this end. As this occurs, a rolling circumference analysis variable, a frequency analysis variable, a pressure loss analysis variable or a combined pressure loss analysis variable can be checked.

Based on the result of the plausibility test, it is preferred to take a decision on whether pressure loss or a disturbance prevails. As a result, false alarms being due to disturbances are avoided.

In addition, the loading and/or a change of loading of the vehicle is determined according to another preferred embodiment. The objective is to detect changes in loading which can have an effect on analysis variables of the individual methods of analysis in order to avoid false alarms due to a change of loading.

Preferably, the detection of loading or change of loading is achieved by combining at least one item of information of a rolling circumference analysis of the wheels with at least one item of information of a frequency analysis of the natural oscillation behavior of at least one tire. These items of information are already available according to the invention, thus obviating the need for additional sensors or like elements for the detection of a change of loading.

Favorably, a reference quantity, which represents an indicator of the configuration of the natural frequency, is determined in the frequency analysis for at least one wheel. It is especially favorable when such a reference quantity is determined for each wheel. The energy content of the spectrum in the range of the natural frequency is used as a reference quantity with particular preference. The reference quantity/quantities or a ratio of reference quantities is/are used for the detection of loading and/or change of loading. The ratio of the reference quantities between front wheels and rear wheels is especially preferred to be employed.

In an improvement of the invention, the determination of a loading and/or change of loading causes a variation of the warning threshold(s) of the analysis variables and/or a compensation of the analysis variables. Advantageously, the load-responsive pressure loss analysis variables are compensated or the warning thresholds of the load-responsive pressure loss analysis variables are adapted.

According to another preferred embodiment, in particular in the frequency analysis, a temperature compensation of an analysis variable, in particular a frequency analysis variable, of at least one tire is performed. This offers the advantage that the influence of the tire temperature on the tire can be taken into consideration. The risk of false alarms or the risk of absence of alarms in the case of pressure loss during travels with major temperature variations is reduced thereby. It is with particular preference that a temperature compensation of a natural frequency of the tire that is determined by the frequency analysis is performed.

To determine a temperature compensation quantity, it is preferred to use a tire temperature which is calculated using a temperature model. The temperature compensation quantity for the frequency analysis is advantageously a quotient of the variation of the frequency analysis variable to the change of temperature.

Preferably, the analysis variable is considered together with the calculated tire temperature over one or more travels in order to learn in the compensation quantity. This safeguards sufficient statistical relevance.

The temperature model preferably considers at least one of the following heat variations: heat flow due to the flexing energy of the tire (\dot{Q}_{Walk}), heat flow due to convection (\dot{Q}_{Convection}), heat flow due to radiation of the tire (\dot{Q}_{Radiation}) or heat flow due to heat input of the vehicle (\dot{Q}_{VehicleCondition}). It is preferred to calculate the tire temperature by time integration based on at least one of the heat variations, with quite particular preference based on the sum of all heat variations.

Favorably, at least two of the following quantities are taken into consideration in the temperature model: outside temperature, temperature in a control unit, engine air intake temperature, coolant temperature, engine temperature, brake temperature, immobilization time of the vehicle, driving profile since the ignition has been switched on, especially preferred the vehicle speed, yaw rate, lateral acceleration, drive torque and/or kilometers covered, ambient sensor information such as rain sensor information and/or dew point sensor information.

One advantage of the method of the invention can be seen in the improved suppressing or avoiding of false alarms or the absence of alarms when pressure loss occurs.

The invention also relates to a computer program product which defines an algorithm according to the method described hereinabove.

Further preferred embodiments can be seen in the following description by way of the Figures.

### BRIEF DESCRIPTION OF THE DRAWINGS

In the accompanying drawings,

FIG. 1 is a schematic block diagram of an exemplary method;

FIG. 2 is a schematic block diagram relating to an embodiment for the combination of the two methods of analysis;

FIG. 3 shows a characteristic field for warning indication of wheel-individual pressure loss;

FIG. 4 shows an influence of the correlation between rolling circumference analysis and natural frequency analysis on the warning thresholds in a characteristic field of warning;

FIG. 5 is a warning strategy for warning indication of tire inflation pressure loss by way of four characteristic fields of warning;

FIG. 6 is a schematic block diagram relating to temperature compensation in the frequency analysis; and

FIG. 7 is a schematic block diagram relating to a tire temperature calculation.

### DETAILED DESCRIPTION OF THE INVENTION

In the publication WO 2005/072995 A1 ‘Method of indirect tire pressure monitoring’ a system is described which infers pressure loss from the change of rolling circumference analysis variables in combination with changes of torsion natural frequencies of the tire. The objective of the method of the invention is to solve the following problems of the prior art method:

1. Availability of the System:

The two methods of analysis (rolling circumference analysis and natural frequency analysis) have difference requirements or conditions in order to be active and furnish reliable values. In the event of warning thresholds which do not adapt to these different activity states/availability conditions, there will be an increased risk of false alarms or risk of absence of alarms when pressure loss occurs.

2. Influencing of Thresholds:

The publication WO 2005/072995 A1 deals with the case that the warning thresholds for the rolling circumference analysis variables are adapted depending on the correlation of the two pressure loss analysis variables (e.g. frequency shift and rolling circumference difference or rolling circumference variation, respectively) and the absolute value of the frequency shift. Adaptation of the warning thresholds for the frequency shift (frequency analysis variable) is not disclosed.

3. Signal Plausibility:

The analysis variables, in particular those of the natural frequency analysis, are subject to statistical variations and influences of road conditions. The result may be that e.g. a rapid decline of natural frequency is detected by the algorithm without pressure loss having occurred. This can lead to false alarms.

4. Loading:

The rolling circumference analysis variable reacts to an increase in loading in the same way like to pressure loss. Consequently, it is impossible to make a distinction between an increase in loading and pressure loss alone based on values from the rolling circumference analysis. This augments the risk of false alarms especially with learning operations with the vehicle unloaded and a later travel with the vehicle loaded.

5. Temperature Influence:

The temperature has an influence on the pressure in the tire (raised temperature=>increase in pressure=>increased rigidity=>increase in natural frequency). However, the rigidity of the tire material (rubber) is also influenced by the temperature (increase in temperature=>softer rubber=>reduced rigidity=>reduction in natural frequency). It has proved that the two effects do not compensate for in their influence on the natural frequency, but that the effect depends on material, tire temperature and internal pressure. During travels with high temperature variations, this causes variations of the natural frequencies in tires which lie in the size range of pressure loss, what is accompanied by an increased risk of false alarms or the risk of no alarm during pressure loss.

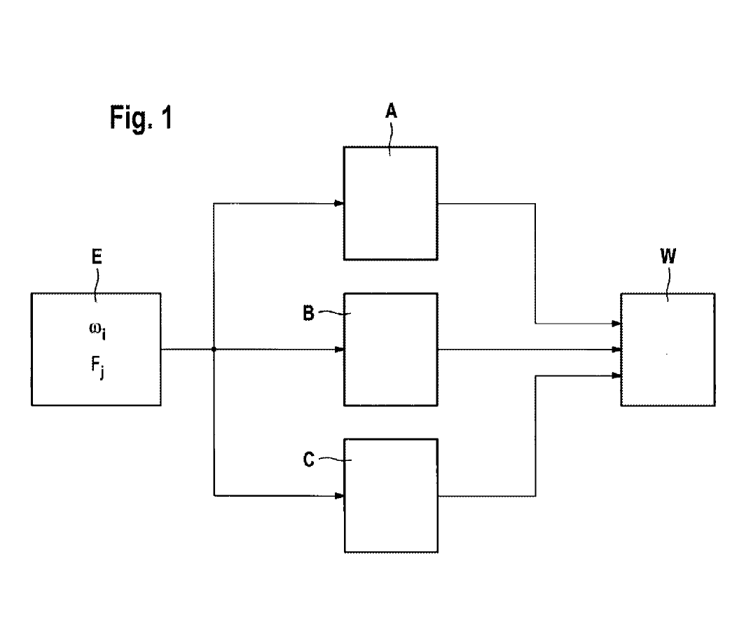

FIG. 1 illustrates a schematic block diagram of an exemplary method solving the above-mentioned problems. The wheel rotational speed sensor signals ωᵢ or coherent quantities and/or driving condition information and/or vehicle information Fⱼ are included as input quantities (block E) in the exemplary method. The overall system consists of three method branches A, B, C which can trigger an alarm (block W) irrespective of one another: Block A: rolling circumference analysis, block B: combination of rolling circumference analysis and frequency analysis, and block C: frequency analysis.

### Block A—Rolling Circumference Analysis:

An indirectly measuring tire pressure monitoring system known in the art is used. Pressure losses at a tire can be detected in this branch A. More particularly, a system based on the evaluation of the test variables DIAG, SIDE, AXLE can be used. To this end, three test variables (DIAG, SIDE, AXLE) are determined simultaneously or consecutively, in which case quantities are included in each test variable (DIAG, SIDE, AXLE) which describe the rotations of the wheels such as the times of one wheel rotation, the rolling circumference, etc. The test variables basically consist of a quotient comprising in its numerator and denominator in each case the sum of two quantities reflecting the wheel rotations. In the numerator of the test variable DIAG, for example, the sum of the quantities of the wheel rotation of the two diagonally opposed wheels (e.g. front left wheel and right rear wheel) is written, whilst in the denominator the sum of the remaining quantities of the wheel rotations (e.g. front right wheel and left rear wheel) is written. As regards the test variable SIDE, for example, the quantities of the wheel rotations of one vehicle side (e.g. right front wheel and right rear wheel) are written in the numerator, whilst in the test variable AXLE the quantities of the wheel rotations of the wheels of one axle (e.g. right front wheel and left front wheel) are written in the numerator. The denominators are produced from the remaining quantities of the wheel rotations in each case. These test variables can be determined in different speed intervals, wheel torque intervals, and lateral acceleration or yaw rate intervals. Furthermore, rolling circumference analysis variables are determined between actual and learnt values for the pressure loss warning indication (ΔDIAG, ΔSIDE, ΔAXLE). These rolling circumference analysis variables are consequently also determined in the intervals from one actual value and the learnt value associated with the actual interval.

### Block B—Rolling Circumference Analysis and Frequency Analysis:

The combination of the rolling circumference analysis and the frequency analysis renders it possible to detect pressure losses on one to three wheels in a robust fashion.

### Block C—Frequency Analysis

In the event of pressure loss on all four tires, the rolling circumference analysis furnishes a contribution to pressure loss detection within very narrow limits only. For this case, the frequency analysis alone furnishes reliable pieces of information and can trigger the alarm.

A branching into paths A and B is made with each new and valid result from the rolling circumference analysis. Paths B and C are taken with each new and valid result of the frequency analysis. Block B and block C will be dealt with in detail once more in the following.

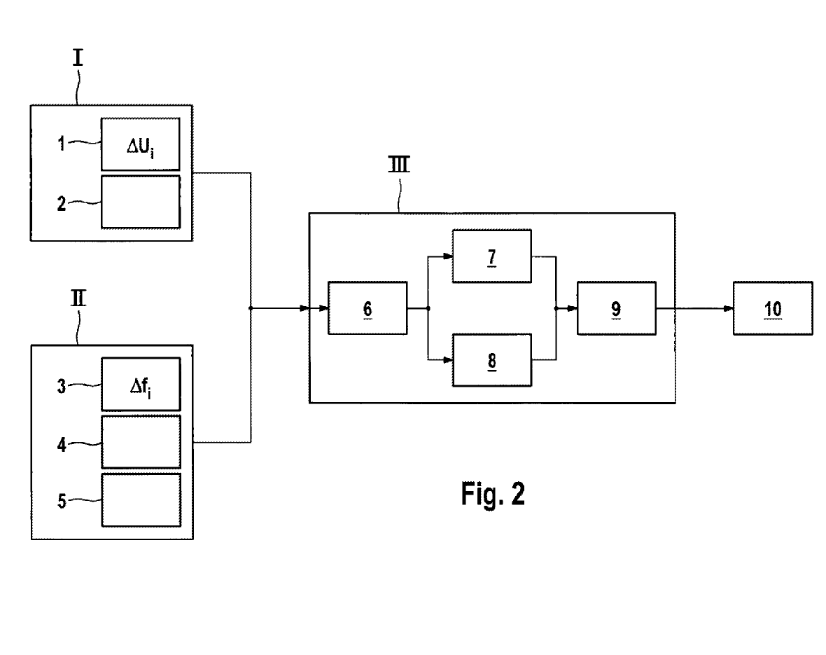

FIG. 2 shows a schematic block diagram with respect to an embodiment for the combination (block B in FIG. 1) of the two methods of analysis, i.e. rolling circumference analysis I and frequency analysis II. Pressure loss analysis variables are calculated for the rolling circumference analysis I in block 1. To this end, wheel-individual rolling circumference analysis variables ΔUᵢ (e.g. i=1, 2, 3, 4, index i refers to one wheel, respectively, e.g. i=1 means left front wheel, etc.) are calculated from the rolling circumference analysis variables. Preferably, the method disclosed in publication WO 2005/072995 A1 is used. Pressure loss analysis variables are calculated in the natural frequency analysis II in block 3. For this purpose, at least on wheel-individual natural frequency analysis variable Δfᵢ (the index i implies also in this case one wheel, respectively, corresponding to the rolling circumference analysis variables ΔUᵢ), e.g. a natural frequency or natural frequency shift, is determined, for example according to a method as disclosed in publication WO 2005/072995 A1 or WO 2005/005174 A1. A signal plausibility test of the corresponding analysis variables is performed in blocks 2 and 5 by way of example. The configuration of the natural frequency and/or the energy content of the spectrum is investigated and determined in block 4 as an example. For example, a reference quantity is determined to this end, providing a statement about the energy contained in the relevant range of the spectrum. It is likewise possible to determine a dimension figure for the configuration of the natural frequency. This reference quantity is of major importance especially for the detection of loading. The items of information from rolling circumference analysis I and frequency analysis II are employed to execute a warning strategy III which can lead to a warning 10, e.g. in the way of actuating a warning lamp.

Either the influence of a disturbance or an actual quick pressure loss can be concerned in the case of a quick change of one or more of the pressure analysis variables ΔUᵢ, Δfᵢ, as has been described hereinabove. To make a distinction whether a disturbing influence or an actual pressure loss is at issue, the time history is evaluated in the signal plausibility test (block 2 or 5). The evaluation is founded on the basic idea that during a disturbance the pressure loss analysis variable ΔUᵢ, Δfᵢ generally stays on a fixed level after the quick decline, while a sudden pressure loss, e.g. caused by a tire damage that occurred during driving, makes the pressure loss analysis variable ΔUᵢ, Δfᵢ decline still further.

The variation of each pressure loss analysis variable ΔUᵢ, Δfᵢ as a function of time is evaluated in one embodiment. When the variable is above a defined threshold, a quick pressure loss or the influence of a disturbance is assumed. A possible warning is initially prevented, and the signal is monitored for an additional period of time. When the pressure loss analysis quantity ΔUᵢ, Δfᵢ continues to rise in the following interval of observation, sudden pressure loss can be inferred therefrom and the warning is admitted. However, when the pressure loss analysis variable ΔUᵢ, Δfᵢ remains on the raised level, a disturbing influence is inferred therefrom, and the warning is furthermore prevented. Only a continued increase can release the warning, or a decline below the critical range will return the system into its normal condition (no warning prevention).

Since it is possible to deflate the rites upon standstill of the vehicle, resulting in a sudden decline of the pressure loss analysis variable ΔUᵢ, Δfᵢ which is plausible though, such a plausibility test will not become active until the vehicle has traveled already for a certain time without standstill.

The warning strategy II is based, among others, on the availability of the system or the subsystems, respectively. The following conditions with regard to the activity of the two systems rolling circumference analysis I and natural frequency analysis II can occur during the operations:
Both systems I, II are available and supply values in short intervals (block 7)
Only one system is active (block 8):
   Rolling circumference analysis I furnishes actual values, natural frequency analysis II already for some time has not furnished values (restriction due to driving conditions) or has never before furnished values (not yet learnt or not yet initialized after start of travel).
      Natural frequency analysis II furnishes actual values, rolling circumference analysis I already for some time has not furnished values (restriction due to driving conditions) or has never before furnished values (not yet learnt or not yet initialized after start of travel).

The treatment of each individual state and the transitions between the states is founded on the following basic ideas:
Both systems I, II are available only if the distance between two values which arrived from different systems does not exceed a defined time t (e.g. one minute). A consideration of correlation and a mutual influencing of the warning thresholds (block 9) can occur in this status.
The transition between the status ‘both systems are available’ (block 7) and ‘only one system is active’ (block 8) is time-controlled or sample-controlled. In this arrangement, the warning thresholds are smoothly adapted (block 9). Due to its augmented uncertainty relating to the signal, one single system is given a higher warning threshold than the combination of both systems.

Another aspect of the embodiment which is schematically illustrated in FIG. 2 is the detection of loading (block 6). In general, each method which indicates a change of loading, or a combination of various methods for loading detection is well suited for implementation in a method of the invention.

Loading causes a rise of the wheel loads. In the input values of the warning strategy, this leads to an increase in the pressure loss analysis variable ΔUᵢ for the loaded wheels in the rolling circumference analysis I and can thus cause false alarm of the system. Therefore, loading detection module 6 upon detection of a change of loading will initially block an alarm and induce the system to learn in compensation values, in particular for the values from the rolling circumference analysis ΔUᵢ in the embodiment. The alarm is released again after compensation has taken place.

Loading detection 6 is realized based on the wheel rotational speed signals ωᵢ only in another embodiment. The pieces of information from rolling circumference analysis I and frequency analysis II are combined for this purpose. As has been explained hereinabove, additional loading will cause the wheel loads to rise, what leads to an increase of the pressure loss analysis variables ΔUᵢ for the loaded wheels in the rolling circumference analysis I. In the frequency analysis II an increase in loading will not influence the natural frequency, however, it causes an increase in energy in the spectrum and a more pronounced configuration of the natural frequency. Since enhanced stimulation of the tire due to a rougher road has the same effect as an additional loading, it is not sufficient to review the absolute energy/distinctness. The ratio of the energies/distinctness of the natural frequency should rather be produced between front and rear axles.

The fundamental idea of this embodiment of a loading detection module 6 will be explained in the following by way of the example of rear-axle loading:
If:
   After standstill and loading on the rear axle pressure loss on the rear axle is indicated by the rolling circumference analysis I,
and:
   The natural frequency analysis II does not show a significant shift of the natural frequency on the rear axle,
and in addition:
   Either the absolute value of the energy/the distinctness of the spectrum on the rear wheels, in comparison to a previously taught-in state, has risen or the ratio of these quantities from front to rear has changed,
then:
   A possible change of loading is considered to prevail, and either the warning thresholds in the characteristic field of warning are adapted (block 9) or a compensation quantity is determined for the rear-axle values from the rolling circumference analysis I.

Another aspect of the embodiment that is schematically illustrated in FIG. 2 is the warning decision (block 9) in which a decision is taken whether a pressure loss warning 10 is or is not issued. An important point is the influencing of the thresholds of the individual pressure loss analysis variables ΔUᵢ, Δfᵢ or combined pressure loss analysis variables for pressure loss detection.

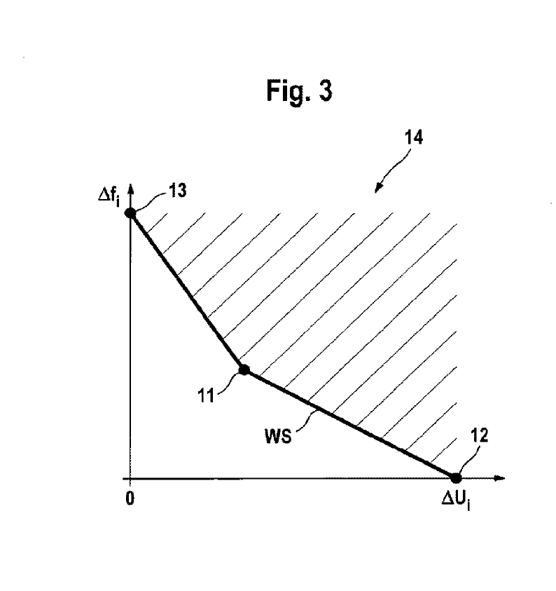

When both systems are active (block 7), both the information (absolute values) of the single systems and the correlation of the two systems are combined with each other by the following exemplary method. The two wheel-individual pressure loss analysis variables ΔUᵢ, Δfᵢ from rolling circumference analysis I and natural frequency analysis II of a tire (i is fixed) are combined in a characteristic field of warning 14 to become one single pressure loss analysis variable. This is schematically illustrated in FIG. 3. Plotted on the x-axis is the pressure loss analysis variable ΔUᵢ of a tire from the rolling circumference analysis I and plotted on the y-axis is the pressure loss analysis variable Δfᵢ of a tire from the natural frequency analysis II. No pressure loss warning 10 is issued below the connecting line of points 13, 11, 12 (warning threshold WS), above the connecting line the combined pressure loss analysis variable amounts to more than 100% and a warning 10 is issued.

The basic idea of the characteristic field of warning 14 consists in that a high combined pressure loss analysis variable is achieved only if both pressure loss analysis variables ΔUᵢ, Δfᵢ indicate pressure loss. If only one system I or II indicates pressure loss, it must have a very high value in order to trigger a warning 10. Characteristic of the exemplary field of warning are the three points 11, 12 and 13:
Point 11—point of intersection:
   If both values are above this point, the combined pressure loss analysis variable is higher than 100%.
12—piercing point rolling circumference analysis axis:
   If the natural frequency analysis II does not indicate pressure loss, the rolling circumference analysis variable ΔUᵢ must indicate a value above this point in order that the combined pressure loss analysis variable becomes higher than 100%.
13—piercing point natural frequency analysis axis:
   If the rolling circumference analysis variable I does not indicate pressure loss, the natural frequency analysis must indicate a value Δfᵢ above this point in order that the combined pressure loss analysis variable becomes higher than 100%.

Thus, a wheel-individual correlation between the two systems I and II is initially produced.

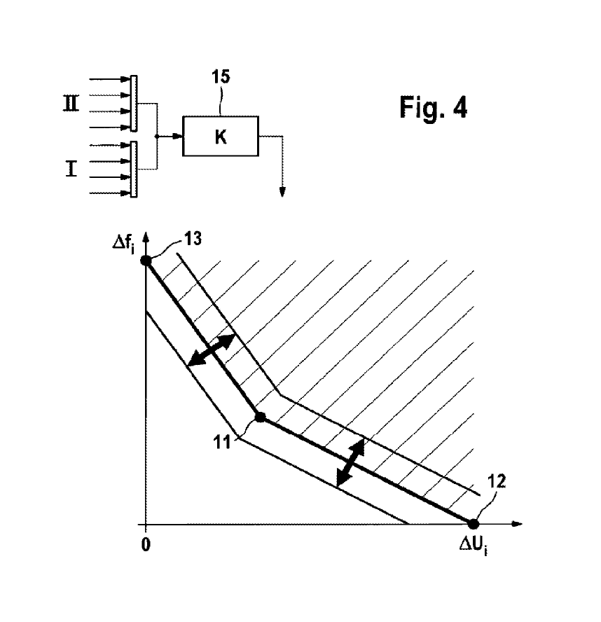

In addition, an evaluation is made in another embodiment which is schematically illustrated in FIG. 4 in as far as rolling circumference analysis I and natural frequency analysis II exhibit the same pressure loss scenario. To this end, a correlation quantity K is calculated e.g. in block 15. The position of the warning threshold WS can then be changed depending on the correlation quantity K, as is schematically indicated in FIG. 4. When a very good correlation is achieved, there is high confidence in the values found and the threshold WS is lowered (direction origin in FIG. 4). When the correlation is poor, the warning threshold WS is shifted to the top (direction top right in FIG. 4).

In a transition from the state ‘both systems active’ (block 7) to ‘only one system active’ (block 8), the pressure loss value (the pressure loss analysis variable) of the inactive system is successively reduced to zero. Also, the piercing point of the characteristic field of warning at the axis of the active system is raised by a factor. As a result, the ability to warn is obtained even if only one system is available, reducing the risk of false alarms in addition.

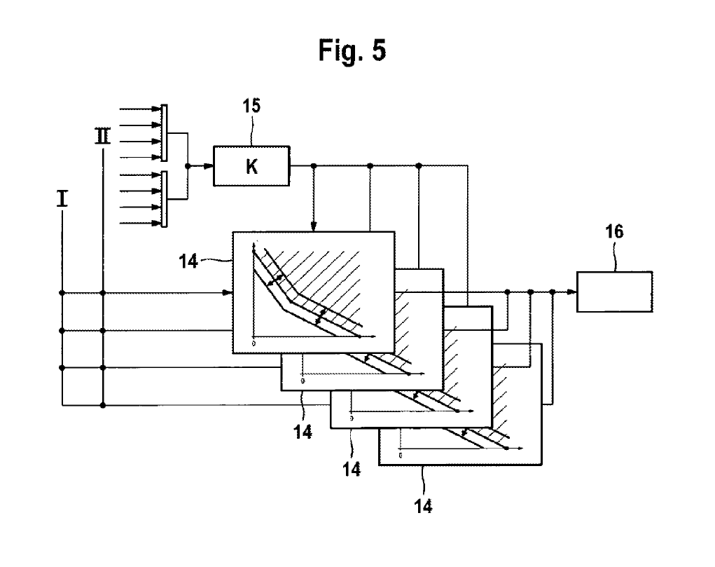

In another embodiment which is illustrated schematically in FIG. 5, the maximum 16 of the combined pressure loss analysis variables of four characteristic fields of warning 14 (one per wheel) is taken into account to initiate a warning 10. If this maximum 16 with a sufficient statistical significance is above 100%, the warning 10 is issued, e.g. in the form of a warning lamp.

Since the differences, quotients or the like of the rotational speeds (or hence directly coherent quantities such as times of revolution or circumferences) are evaluated with respect to each other in a rolling circumference analysis, the rolling circumference analysis is almost ‘blind’ in the event of pressure loss on four wheels. For the warning indication of a simultaneous four-wheel pressure loss, as has been mentioned hereinabove, only those items of information, e.g. the pressure loss analysis variable(s), from the frequency analysis are therefore evaluated (block C in FIG. 1). The natural frequency shift is used in the following description as an example for a pressure loss analysis variable from the frequency analysis.

This is, however, also possible with a pressure loss analysis variable which results from the frequency shift and further quantities that describe spectra, as is e.g. described in detail in publication WO 2005/005174 A1. According to the example, a frequency shift is given for each wheel.

The following conditions for a warning 10 must be satisfied in this branch C:
1. All four pressure loss analysis variables from the frequency analysis (frequency shifts) must indicate pressure loss above a defined threshold (e.g. 80% of a warning threshold).
2. At least one tire must indicate a value above the 100% threshold.

Furthermore, plausibilisation of the result using the rolling circumference analysis variables is possible. The variables must not indicate significant pressure loss at single positions.

Another aspect in the frequency analysis is a compensation of the influence of temperature. According to the example, the natural frequency fₖ (the index k can relate to FL: front left, FR: front right, RL: rear left, or RR: rear right) of the tire is taught in together with a calculated tire temperature. A compensation quantity for the temperature influence is found in this ensemble and is applied with regard to the determined natural frequencies.

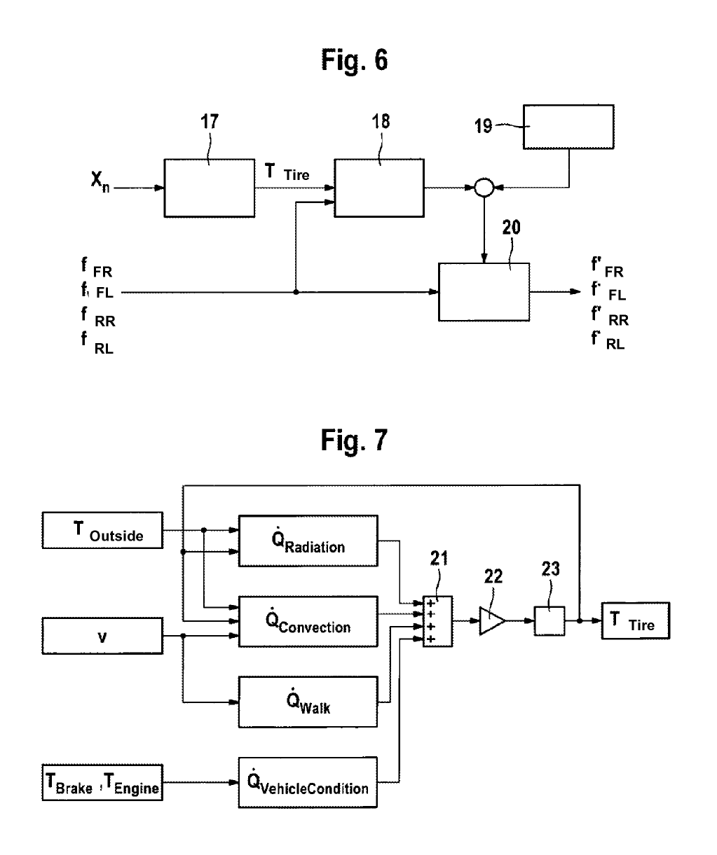

In FIG. 6 a schematic block diagram for the temperature compensation is shown in a frequency analysis. In the beginning, before a compensation value prevails, initially an empirical average value (e.g. −0.5 hertz/10° C.) is taken as a basic compensation 19. During the learning operation, a tire temperature Tₜᵢᵣₑ is then calculated by means of a temperature model 17, based on different items of information related to driving, driving conditions, vehicle and environment Xₙ, such as outside temperature, immobilization time, coolant temperature, driving speed, driving profile, etc. Furthermore, the natural frequencies of the wheels f_{FL}, f_{FR}, f_{RL}, f_{RR} are determined correspondingly. A correction factor 18 is taught in when temperature/frequency values prevails. The correction factor is used in order to determine from the basic compensation 19 an actual temperature compensation value 20 which allows determining the temperature-compensated natural frequencies f′_{FL}, f′_{FR}, f′_{RL}, f′_{RR}.

The spread of the temperature Tₜᵢᵣₑ is evaluated when the correction factor 18 is learnt. The correction factor 18 will not be accepted until the spread of the learnt temperature/frequency ensemble with regard to the temperature Tₜᵢᵣₑ (e.g. lowest temperature to highest temperature and a sufficient number of pairs of values above this range) is of sufficient size.

The temperature model 17 uses the following pieces of information, for example, for the calculation of the tire temperature Tₜᵢᵣₑ:
Outside temperature T_{outsider}, obtainable either by way of a temperature sensor in the control unit or by way of CAN messages, such as the combined outside temperature and intake air temperature,
Immobilization time of the vehicle: Assessment sometimes by way of the coolant temperature or engine temperature T_{Engine} in combination with the outside temperature T_{outsider} in case there is no immobilization time,
driving profile, obtainable from the speed signal v, yaw rate or lateral acceleration as well as drive torque. In addition, calculated quantities such as kilometers traveled since ‘ignition-on’, and
rain sensor or dew point sensor information in order to infer the moisture of the road therefrom.

These pieces of information are combined by means of a temperature model 17 which enters the heat flow \dot{Q} through flexing energy \dot{Q}_{Walk}, convection \dot{Q}_{Convection} and radiant heat \dot{Q}_{Radiation} into the balance sheet in a first embodiment and calculates a tire temperature therefrom. In another term \dot{Q}_{VehicleCondition} for ambient conditions, influences of the vehicle such as brake temperature and engine temperature are taken into consideration.

Possible equations for calculation are: radiation/radiant heat:

\dot{Q}_{Radiation}=ε·σ—A·(T_{outside}⁴−Tₜᵢᵣₑ⁴)αₛ·=(T_{outside}⁴−Tₜᵢᵣₑ⁴)

convection:

\dot{Q}_{Convection}=αₖ·\sqrt{v}·(T_{outside}−Tₜᵢᵣₑ)

flexing energy:

\dot{Q}Walk=f·m·g·v=f·F_{z}·v

vehicle conditions/vehicle heat input:

\dot{Q}_{VehicleCondition}=f(T_{Brake}, T_{Engine}, . . . )

with
ε: emissivity,
σ: Stefan-Boltzmann constant,
A: radiating surface of the tire,
αₛ: proportionality constant of the radiant heat,
αₖ: proportionality constant of the convection,
f: proportionality constant of the rolling resistance,
F_{z}: wheel load,
v: speed,
T_{outside}: outside temperature,
Tₜᵢᵣₑ: tire temperature, and
f(T_{Brake}, T_{Engine}, . . . ): function of the brake temperature T_{Brake}, the engine temperature T_{Engine} and further quantities.

The tire temperature Tₜᵢᵣₑ can be calculated based on:

Tₜᵢᵣₑ=1/c_{Rtire}·∫(\dot{Q}_{Convection}+\dot{Q}_{Radiation}+\dot{Q}_{Walk}+\dot{Q}_{VehicleCondition})dt+T_{Start}

with cₜᵢᵣₑ: heat capacity of the tire.

FIG. 7 schematically illustrates an exemplary method for the calculation of the tire temperature Tₜᵢᵣₑ according to the above equation. Based on outside temperature T_{outside}, driving speed v, brake temperature T_{Brake}, engine temperature T_{Engine} and a start value T_{Start} for the tire temperature, the four heat flow contributions \dot{Q}_{Walk}, \dot{Q}_{Convection}, \dot{Q}_{Radiation} and \dot{Q}_{VehicleCondition} are calculated, added in block 21, divided in block 22 by the heat capacity cₜᵢᵣₑ and integrated as a function of time in block 23. The resultant tire temperature Tₜᵢᵣₑ is used to calculate new heat flow contributions \dot{Q}_{Convection}, \dot{Q}_{Radiation}.

In an especially simple embodiment, the radiation component \dot{Q}_{Radiation} is ignored. A minimum speed v in the capacity of an input for the convection equation is assumed as a compensation for the hence missing temperature reduction.

The plausibilisation values from the immobilization time must be taken into account to determine a start value Tₛₜₐᵣₜ.

According to another embodiment, the influence of temperature is also taken into consideration for the analysis variables ΔDIAG, ΔSIDE, ΔAXLE of the rolling circumference analysis. The test variables DIAG, SIDE, AXLE together with a calculated tire temperature are learnt.

In another embodiment, the temperature compensation described above is performed also in the frequency analysis II of the combined method B.

1-22. (canceled)

23. A method for indirect tire pressure monitoring comprising:
performing a rolling circumference analysis of tires, in which rolling circumference analysis variables (ΔDIAG, ΔSIDE, ΔAXLE) are determined from actually found and learned test variables describing rotation of the wheels, and a frequency analysis of the natural oscillation behavior of at least one tire in which at least one frequency analysis variable (fₖ) is determined, wherein an evaluation of the rolling circumference analysis (A) and the natural frequency analysis (C) and a combined evaluation (B) of both methods of analysis is performed for warning indication of tire pressure loss.

24. A method according to claim 22, wherein a natural frequency analysis is performed for each tire.

25. A method according to claim 22, wherein wheel-individual pressure loss analysis variables (ΔUᵢ, Δfᵢ) are determined in each case for rolling circumference analysis (I) and frequency analysis (II) in the combination of both methods of analysis (B).

26. A method according to claim 22, wherein the combination of both methods of analysis (B), warning thresholds (WS) of each of the two methods of analysis are selected depending on the analysis variables (ΔUᵢ, Δfᵢ), in particular the wheel-individual pressure loss analysis variables, of the respectively other method.

27. A method according to claim 26, wherein the combination of both methods of analysis (B), warning thresholds (WS) of each of the two methods of analysis are selected depending on the analysis variables (ΔUᵢ, Δfᵢ), in particular the wheel-individual pressure loss analysis variables, of the respectively other method and a rate of correlation (K) between the two methods of analysis.

28. A method according to claim 27, wherein the warning thresholds (WS) are changed depending on the availability (7, 8) of the analysis variables (ΔUᵢ, Δfᵢ), in particular the pressure loss analysis variables.

29. A method according to claim 27, wherein for at least one wheel, a combined wheel-individual pressure loss analysis variable is determined, in particular by way of a characteristic field of warning (14), into which the pressure loss analysis variables (ΔUᵢ, Δfᵢ) and in particular the warning thresholds (WS) of both methods of analysis are included.

30. A method according to claim 22, wherein a warning (10) with regard to tire pressure loss is issued depending on at least two, in particular depending on all, of the combined wheel-individual pressure loss analysis variables.

31. A method according to claim 30, wherein the warning (10) is issued based on the maximum (16) of the combined wheel-individual pressure loss analysis variables.

32. A method according to claim 22, wherein a plausibility test (2, 5) of the defined value is performed based on the change with time of the analysis variable for at least one of the determined analysis variables (ΔUᵢ, Δfᵢ), in particular rolling circumference analysis variable, frequency analysis variable, pressure loss analysis variable or combined pressure loss analysis variable.

33. A method according to claim 32, wherein based on the result of the plausibility test (2, 5), a decision is taken on whether pressure loss or a disturbance prevails.

34. A method according to claim 22, wherein the loading and/or a change of loading of the vehicle is determined (6).

35. A method according to claim 34, wherein the detection of loading and/or change of loading (6) is determined from combining at least one item of information of a rolling circumference analysis (I) of the wheels with at least one item of information of a frequency analysis (II) of the natural oscillation behavior of at least one tire.

36. A method according to claim 35, wherein the frequency analysis (II), a reference quantity which represents an indicator of the configuration of the natural frequency, in particular the energy content of the spectrum in the range of the natural frequency, is determined for at least one wheel, in particular for each wheel, and in that the reference quantity/quantities, in particular ratios of reference quantities, is/are used for the detection of loading and/or change of loading (6).

37. A method according to claim 35, wherein the ratio of the reference quantities between front wheels and rear wheels is employed.

38. A method according to claim 35, wherein the determination of loading and/or change of loading (6) causes a change of the warning thresholds (WS) of the analysis variables (ΔUᵢ, Δfᵢ), in particular the load-responsive pressure loss analysis variables, and/or a compensation of the analysis variables, in particular the load-responsive pressure loss analysis variables.

39. A method according to claim 22, wherein a temperature compensation (20) of an analysis variable (fₖ, ΔDIAG, ΔSIDE, ΔAXLE), in particular of the natural frequency, of at least one tire is performed.

40. A method according to claim 39, wherein a tire temperature (Tₜᵢᵣₑ) which is calculated using a temperature model (17) is used to determine a compensation quantity, in particular the quotient of the variation of the frequency analysis variable by a change of temperature.

41. A method according to claim 40, wherein the temperature model (17) considers at least one of the following heat variations: heat flow due to the flexing energy of the tire (\dot{Q}_{Walk}), heat flow due to convection (\dot{Q}_{Convection}), heat flow due to radiation of the tire (\dot{Q}_{Radiation}), heat flow due to heat input of the vehicle (\dot{Q}_{VehicleCondition}).

42. A method according to claim 41, wherein for learning the compensation quantity, the analysis variable (fₖ, ΔDIAG, ΔSIDE, ΔAXLE), in particular natural frequency, along with the calculated tire temperature (Tₜᵢᵣₑ), is reviewed for one or several travels.

43. A method according to claim 42, wherein the tire temperature (Tₜᵢᵣₑ) is calculated taking into consideration at least two of the following quantities: outside temperature (T_{outside}), temperature in a control unit, engine air intake temperature, coolant temperature, engine temperature (T_{engine}), brake temperature (T_{brake}), immobilization time of the vehicle, driving profile since the ignition has been switched on, especially vehicle speed (v), yaw rate, lateral acceleration, drive torque and/or kilometers traveled, ambient sensor information, in particular rain sensor information and/or dew point sensor information.
